(19) United States
(12) Patent Application Publication
(10) Pub. No.: US 2026/0187476 A1
(43) Pub. Date: Jul. 2, 2026

(54) SYSTEMS AND METHODS FOR DECISIONING USING DISTRIBUTED ADVANCED COMPUTATIONAL MODELS FOR DATA ANALYSIS AND AUTOMATED PROCESSING

(71) Applicant: BANK OF AMERICA CORPORATION, Charlotte, NC (US)

(72) Inventor: Vijay Kumar Yarabolu, Hyderabad (IN)

(73) Assignee: BANK OF AMERICA CORPORATION, Charlotte, NC (US)

(21) Appl. No.: 19/007,668

(22) Filed: Jan. 2, 2025

(51) Int. Cl. G06N 3/096

(52) U.S. Cl. CPC G06N 3/096

(57) ABSTRACT

Systems, computer program products, and methods are described herein for decisioning using distributed advanced computational models for data analysis and automated processing. The present disclosure is configured to receive a request from an end-point device. A shallow model may be configured to determine whether the request should proceed to a central model. Upon the shallow model determining the request should proceed to the central model, the request and associated metadata may be transferred to the central model. The central model may generate a result via processing the request. The result may be transferred to the end-point device.

### TECHNOLOGICAL FIELD

Example embodiments of the present disclosure relate to decisioning using distributed advanced computational models for data analysis and automated processing.

### BACKGROUND

There are significant issues associated with decisioning using models on a distributed network. Applicant has identified a number of deficiencies and problems associated with conventional solutions for model decisioning using a network. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for decisioning using distributed advanced computational models for data analysis and automated processing.

Embodiments of the present invention address the above needs and/or achieve other advantages by providing apparatuses (e.g., a system, computer program product, and/or other devices) and methods for decisioning using distributed advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the solutions as described herein may receive a request from an end-point device. Further, in some embodiments, the solution may determine, via a shallow model, whether the request should proceed to a central model by determining a preliminary decision associated with the request. Further, in some embodiments, the solution may transfer, upon the shallow model determining the request should proceed to the central model, the request and metadata associated with the request to the central model. Further, in some embodiments, the solution may generate a result via processing the request using the central model. Further, in some embodiments, the solution may transfer the result to the end-point device.

In some embodiments, the shallow model may be associated with the end-point device, and the central model may be associated with a server.

In some embodiments, the shallow model may be associated with an intermediary server, and the central model may be associated with a server.

In some embodiments, the shallow model and the central model may include a machine learning (ML) model.

In some embodiments, the ML model associated with the central model may include at least as many parameters as the ML model associated with the shallow model.

In some embodiments, the shallow model determining the preliminary decision associated with the request may include resolving one or more fundamental queries associated with the request.

In some embodiments, the shallow model, upon the shallow model determining the request should not proceed to the central model, may be configured to reject the request.

In some embodiments, the shallow model may be configured to generate a notification associated with the rejection of the request. In some embodiments, the shallow model may be configured to configure a display associated with the end-point device to display the notification.

In some embodiments, upon the shallow model determining the request should proceed to the central model, the solution may generate a hash value, wherein the hash value may include the request and the metadata associated with the request. In some embodiments, upon the shallow model determining the request should proceed to the central model, the solution may validate, via the central model, the hash value.

In some embodiments, transferring the result to the end-point device may include generating a hash value, wherein the hash value may include the request and the metadata. In some embodiments, transferring the result to the end-point device may include encrypting the result using the hash value. In some embodiments, transferring the result to the end-point device may include decrypting, via the end-point device, the result.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for decisioning using distributed advanced computational models for data analysis and automated processing, in accordance with an embodiment of the disclosure;

FIG. 2 illustrates an exemplary generative AI subsystem, in accordance with an embodiment of the disclosure;

FIG. 3 illustrates a process flow for decisioning using distributed advanced computational models for data analysis and automated processing, in accordance with an embodiment of the disclosure;

FIG. 4 illustrates an example technical process flow for decisioning using a shallow model associated with an end-point device and a central model associated with a server, in accordance with an embodiment of the disclosure;

FIG. 5 illustrates an example architecture diagram of the shallow model of the end-point device and the central model of the server, in accordance with an embodiment of the disclosure;

FIG. 6 illustrates an example of the ML model associated with the shallow model and the ML model associated with the central model, in accordance with an embodiment of the disclosure; and

FIG. 7 illustrates example configurations of the shallow model as compared with the end-point device, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The present disclosure describes technology relating to a distributed decision-making system that uses both client-side and server-side machine learning models to optimize computational efficiency, speed, and energy consumption. Specifically, the disclosure provides solutions for a two-tiered approach where lightweight shallow models on the client-side device (e.g., the end-point device 140) perform initial validations, while more complex central models on the server-side handle advanced processing and decision making. Further, the present disclosure provides solutions incorporating encryption and hashing techniques to ensure data security, integrity, and authenticity throughout the process.

Conventional decision-making systems rely heavily on centralized server-side processing. This approach leads to significant challenges, including high network bandwidth consumption, increased server load, and slower response times for the network and for users. Further, transmitting large amounts of raw data to servers increases energy consumption and resource usage, contributing to inefficiencies across the system and exposes sensitive information to security issues during transmission. Current methods are often unable to efficiently handle high request volumes, resulting in system bottlenecks and/or degraded user experiences.

The solutions as provided herein solve the issues of conventional systems by performing an initial check at the user device to determine whether the request should proceed to the central model. In this way, the shallow model on the user device performs the initial checks to determine if the request meets basic criteria. If the shallow model decides the request should not proceed, the shallow model may reject the request. If the shallow model determines the request should proceed, the shallow model will transmit the request, and any associated metadata, to the central model. The central model may then perform further and more advanced processing on the request to generate a result or solution. The central model may then transmit the result to the shallow model and/or user device in order to display the result to the user.

What is more, the present disclosure provides a technical solution to a technical problem. As described herein, the technical problem includes inefficiens in decision-making systems that rely heavily on server-side processing, resulting in increased network traffic, high energy consumption, slower response times, and the like. The technical solution presented herein allows for the distributed processing of requests by implementing client-side shallow models for preliminary validations and server-side central models for advanced processing, ensuring optimized use of resources and faster decision-making. In particular, solutions as provided herein are an improvement over existing solutions to the inefficiencies of centralized processing systems, (i) with fewer steps to achieve the solution, thus reducing the amount of computing resources, such as processing resources, storage resources, network resources, and/or the like, that are being used (e.g., performing basic validations before transmitting the request to the server), (ii) providing a more accurate solution to problem, thus reducing the number of resources required to remedy any errors made due to a less accurate solution (e.g., using centralized models for more advanced processing), (iii) removing manual input and waste from the implementation of the solution, thus improving speed and efficiency of the process and conserving computing resources (e.g., automating the initial validation and rejection process locally without human intervention), (iv) determining an optimal amount of resources that need to be used to implement the solution, thus reducing network traffic and load on existing computing resources (e.g., transmitting only eligible requests that meet decisioning criteria of the central model and rejecting requests that do not meet such criteria). Furthermore, the technical solution described herein uses a rigorous, computerized process to perform specific tasks and/or activities that were not previously performed. In specific implementations, the technical solution bypasses a series of steps previously implemented, thus further conserving computing resources.

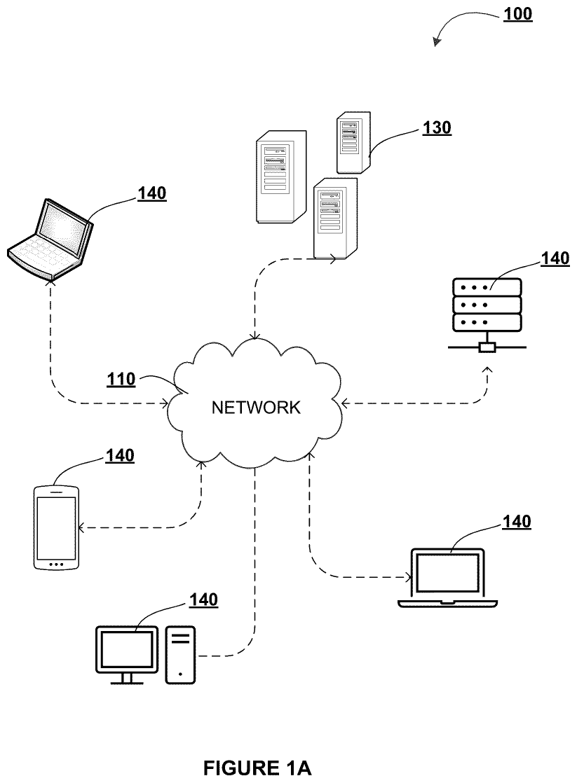

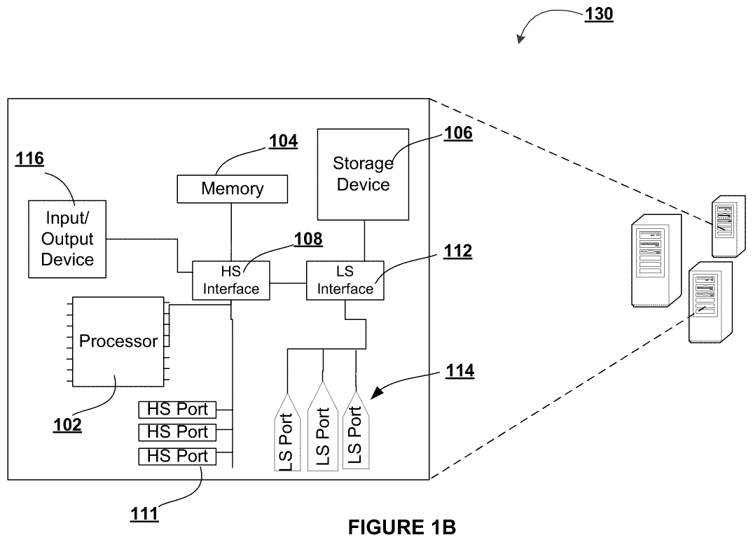

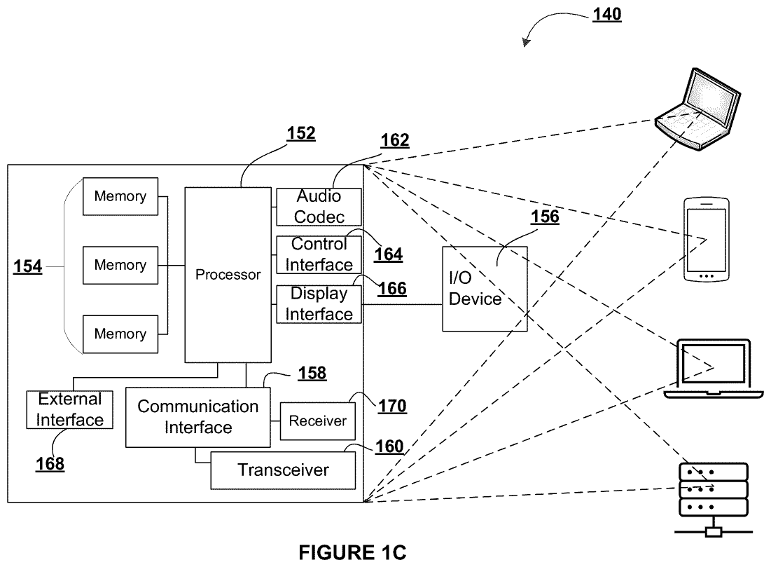

FIGS. 1A-1C illustrate technical components of an exemplary distributed computing environment 100 for decisioning using distributed advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

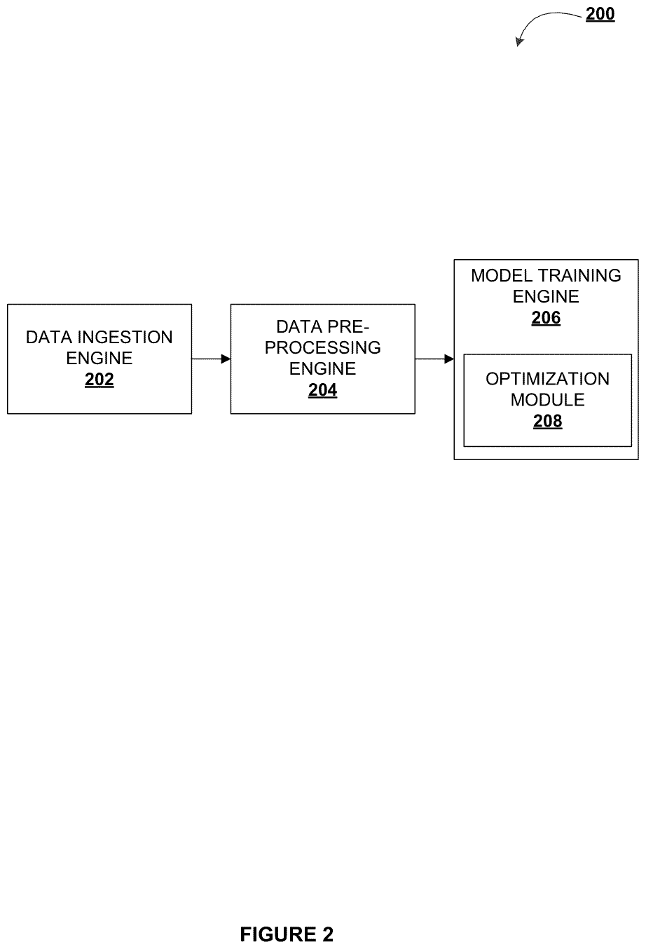

FIG. 2 illustrates an exemplary generative AI subsystem 200, in accordance with an embodiment of the invention. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

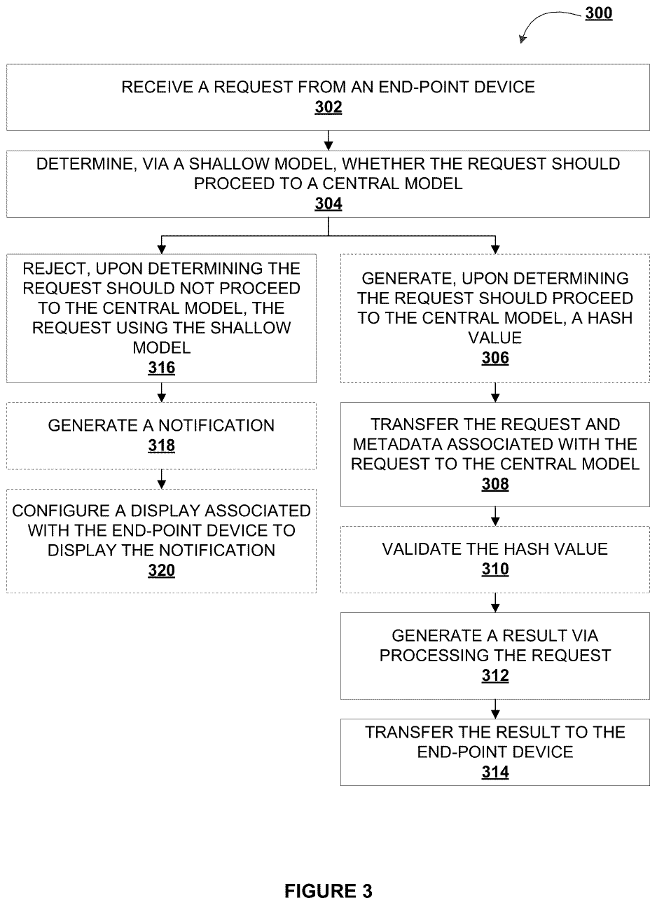

FIG. 3 illustrates a process flow for decisioning using distributed advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a distributed computing system (e.g., similar to one or more of the systems described herein with respect to FIGS. 1A-1C) may perform one or more of the steps of process flow 300. For example, as shown in block 302, the process flow 300 of this embodiment includes receiving a request from an end-point device.

In some embodiments, the request may be received from an end-point device 140. In this way, the end-point device 140 may include a user device associated with a user. In some embodiments, the user may submit the request via the end-point device 140 using the end-point device's 140 communication interface. For example, the end-point device 140 may communicate the request via one or more communication means, such as short messaging service (SMS), multimedia messaging service (MMS), the internet, or the like. In some embodiments, the shallow model 402 may be associated with an application, program, or software on the end-point device 140. For example, an application on the end-point device 140 may allow the user to communicate (e.g., query or request) with the shallow model 402.

As shown in block 304, the process flow 300 of this embodiment includes determining, via a shallow model, whether the request should proceed to a central model. In this way, the identification of features, decisioning attributes, user-specific details, and the like may be used by the shallow model 402 at the user device (e.g., the end-point device 140) to determine whether a request should proceed. For example, these preliminary decisions may include fundamental queries, which may include information such as user identification, user filtering procedures, user-specific information and attributes, and the like. In this way, and in some embodiments, the fundamental queries and preliminary decisions may distinguish a legitimate user attempting to login or use the platform from a malicious or otherwise ill-willed individual. Further, in some embodiments, the fundamental queries and preliminary questions may be used to categorize and/or prioritize the request.

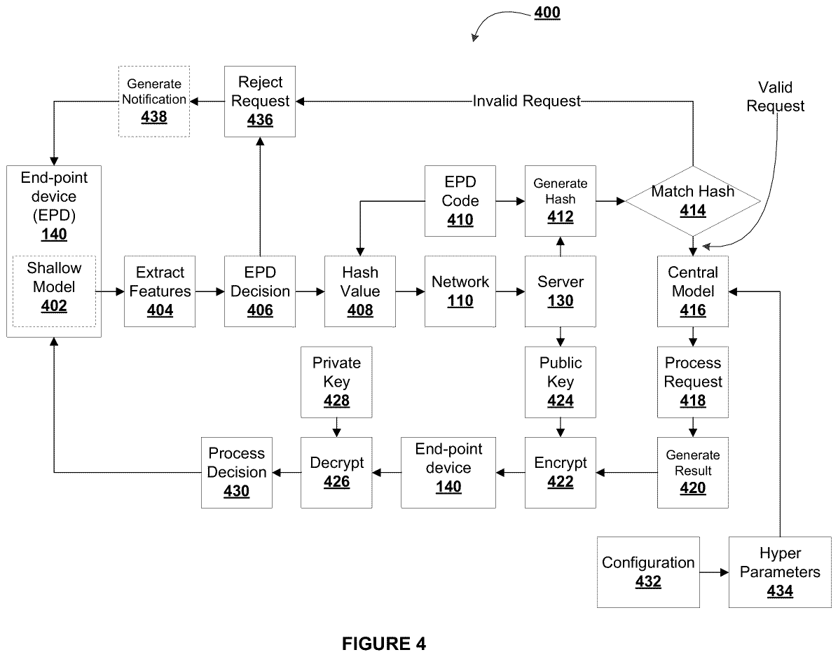

In some embodiments, the shallow model may determine whether the request should proceed to the central model by determining a preliminary decision associated with the request. In some embodiments, the shallow model determining the preliminary decision associated with the request may include resolving one or more fundamental queries associated with the request. In some embodiments, the fundamental queries may be resolved by the shallow model 402. In this way, and as shown in FIG. 4, the shallow model 402 may extract features 404 associated with the user, the user device (e.g., the end-point device 140) or the like in order to resolve the fundamental queries. The features extracted by the shallow model 402 may include fundamental queries such as basic and/or preliminary questions associated with the user, for example. In some embodiments, the features extracted may be provided by the user via a questionnaire, form submission, or the like. In this regard, the fundamental queries may include information associated with the user that may be used to screen or filter the user's request to the central model 416. For example, the fundamental queries may include information such as a credit history for certain requests associated with financial lending requests. Further, in some embodiments, the fundamental queries may include information related to a loan approval, which may include credit history, employment status, loan repayment history, and the like. In this way, the shallow model 402 may make a decision (e.g., the preliminary decision) regarding the user's fundamental queries to determine whether the user's request should proceed to the central model 416.

Further, in some embodiments, the preliminary decisions and fundamental queries may include user filtering attributes. In this way, the user filtering attributes may filter the user and/or the user's request. For example, the filtering may include asking the user basic questions regarding the user request, which may allow the system as described herein to prioritize the user's request accordingly. Further, in some embodiments, the filtering may include pre-processing certain requests that meet certain criteria. In this way, the filtering at the shallow model 402 may pre-process the requests in order to assist the central model 416 during processing of the user's request.

Further, in other embodiments, the preliminary decisioning and/or fundamental queries may include user access requests and/or login attempts. For example, the user may, via the user device, attempt to login to an account by using a security feature such as inputting a personal identification number (PIN), password, using facial recognition software, fingerprint detection software, or the like. The shallow model 402 may, in some embodiments, treat the user's attempt to login using the security features as a fundamental query. For example, the features extracted by the shallow model 402 may include the security features used during the login attempt. In this way, the shallow model 402 may determine whether the user's login attempt should proceed to the central model 416 for further verification or if the user's attempt should be rejected. In some embodiments, the shallow model 402 may determine the login attempt should proceed to the central model 416. In this way, the shallow model 402 may, in some embodiments, allow the request to proceed without approving the login. In this regard, the central model 416 may still make the final decision as to whether the user should be allowed to login to the account.

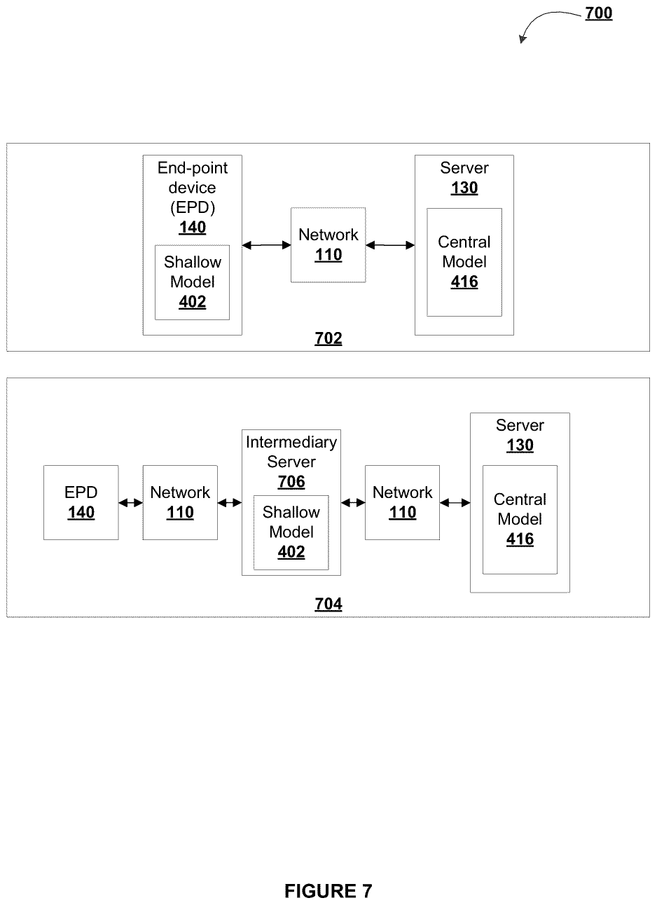

In some embodiments, the shallow model may be associated with the end-point device. Further, in some embodiments, the central model may be associated with a server. In this way, and as shown in block 702 of FIG. 7, the end-point device 140 may include the shallow model 402. For example, the shallow model 402 may be installed or implemented onto the end-point device 140. Further, in some embodiments, the shallow model 402 may be accessible by a user via the end-point device 140. In this regard, the shallow model 402 may not need to communicate with the central model 416, the server 130, the network 110, or the like to function. For example, the shallow model 402 may be able to provide responses to a user's request locally on the end-point device 140 without communication to the central model 416, server 130, or network 110. Further, in some embodiments, the local processing capabilities of the shallow model 402 may allow the user to query the shallow model 402 for answers even when the end-point device 140 is not connected to the network 110, the internet, a cellular telephone network, or the like. Further, in some embodiments, the shallow model 402 may determine that some questions queried offline (e.g., without communication to the network 110, or the like) may need access to the network 110, server 130, or central model 416. In this way, the shallow model 402 may store the offline user queries until the end-point device 140 connects or re-connects to the network 110, the server 130, or the central model 416.

Further, in some embodiments, and as shown in block 704 of FIG. 7, the shallow model 402 may be associated with an intermediary server 706. In some embodiments, the intermediary server 706 may be a different server than the server 130. Further, in some embodiments, the intermediary server 706 may be different than the end-point device 140. In this way, the end-point device 140 may communicate to the intermediary server 706 in order to send the user requests to the shallow model 402. Further, the intermediary server 706 may communicate to the server 130 if the request is determined to be sent to the central model 416. In some embodiments, the end-point device 140, the intermediary server 706, and the server 130 may communicate via the network 110. In some embodiments, the shallow model 402 on the intermediary server 706 may be accessible to end-point devices 140 that may not have the capability to run or otherwise operate the shallow model 402 locally. In this way, the shallow model 402 may be too demanding to run on the end-point device 140 or the end-point device 140 may not have the required software or hardware to properly operate the shallow model 402. For example, mobile devices without the capability to operate the shallow model 402 may communicate with the intermediary server 706 in order to query the shallow model 402. In this way, the mobile device (e.g., end-point device 140) may communicate, via the network 110, to the shallow model 402 using a short messaging service (SMS), text message, voice communication, phone call, or the like, to query and/or send the request to the shallow model 402. In some embodiments, the intermediary server 706 and/or the shallow model 402 may include software, applications, programs, or the like that are used to reconfigure the incoming request from the mobile devices (e.g., the end-point device 140) to a format the shallow model 402 may interpret. For example, an SMS sent from the mobile device may be reconfigured to a different format that the shallow model 402 may ingest and receive in order to continue the process as described herein.

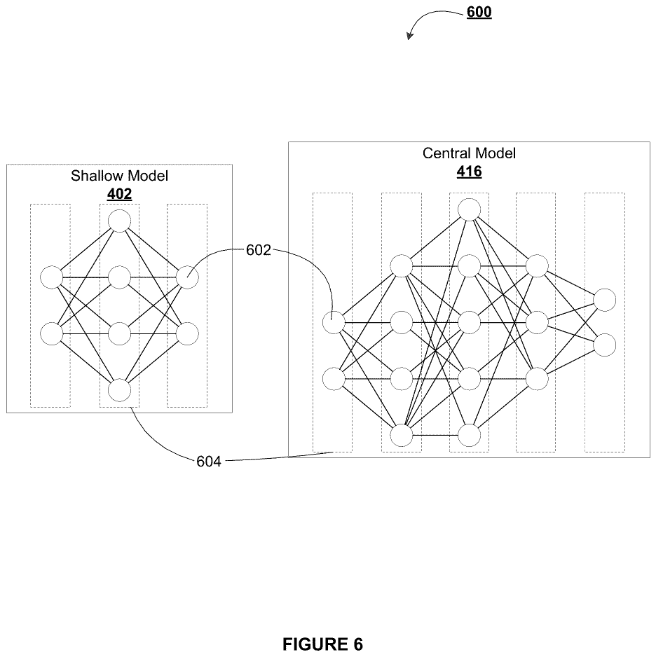

In some embodiments, the shallow model and the central model may include a machine learning (ML) model. In some embodiments, the ML model associated with the central model may include at least as many parameters as the ML model associated with the shallow model. In some embodiments, the ML models of the shallow model 402 and central model 416 may include the components, features, and functionalities associated with the ML model described in FIG. 2. In this way, for example, the shallow model 402 and the central model 416 may include a data ingestion engine (e.g., the data ingestion engine 202), a data pre-processing engine (e.g., the data pre-processing engine 204), a model training engine (e.g., the model training engine 206), and an optimization module (e.g., the optimization module 208). In some embodiments, the central model 416 may be a more sophisticated model than the shallow model 402. In this way, the central model 416 may include at least as many nodes, layers, parameters, or the like as the shallow model 402. For example, and as shown in FIG. 6, the central model 416 may, in some embodiments, include at least as many nodes 602 and/or layers 604 as the shallow model 402.

As shown in block 306, the process flow 300 of this embodiment may include generating, upon determining the request should proceed to the central model, a hash value. In some embodiments, upon the shallow model determining the request should proceed to the central model, the system may be configured to generate a hash value, wherein the hash value may include the request and the metadata associated with the request. For example, as shown in FIG. 4, after the shallow model 402 determines the request should proceed (e.g., in the end-point device decisioning block 406), the hash value 408 may be generated. In some embodiments, the end-point device may generate a code (e.g., EPD code 410) that is used to generate the hash, as shown in block 412.

In some embodiments, the hash generation may include the following one or more steps. In some embodiments, after the shallow model 402 determines the request should proceed to the central model 416, but before transferring the request, the hash value 408 may be generated. In some embodiments, the hash value may be generated using the request data and metadata associated with the request (e.g., client identification information, timestamps, etc.). Further, in some embodiments, the hash and the request may be transmitted to the server 130.

In some embodiments, the system may transfer, upon the shallow model determining the request should proceed to the central model, the request and metadata associated with the request to the central model. For example, as shown in block 308, the process flow 300 of this embodiment includes transferring the request and metadata associated with the request to the central model. In this way, the request and metadata may be transferred over the network 110 to the server 130. In some embodiments, the metadata associated with the request may provide context for processing the request. In this way, the metadata may include, but is not limited to, client identification, timestamps, request types, feature sets, session information, geolocation data, encryption parameters, or the like. Further, in some embodiments, the metadata may be used to distinguish a request from other requests received at the central model 416.

As shown in block 310, the process flow 300 of this embodiment may include validating the hash value. Further, in some embodiments, the central model 416 may validate the hash value, which may include recomputing the hash value based on the received request and metadata and comparing the calculated hash value to the hash value transmitted by the shallow model 402. Further, in some embodiments, the central model 416 may determine the hash value is authentic upon the calculated hash and the transmitted hash values matching (e.g., as shown in block 414 of FIG. 4). In other embodiments, the central model 416 may determine the request is invalid and should be rejected if the hash values do not match. In this way, the central model 416 may reject the request, as shown in block 436. In some embodiments, the request rejection may include generating a notification 438, which may include information about the request, the metadata, the reason for rejection, and the like.

In some embodiments, the system may be configured to validate, via the central model, the hash value. For example, the central model 416 may validate the hash value, which may include recomputing the hash value based on the received request and metadata and comparing the calculated hash value to the hash value transmitted by the shallow model 402. Further, in some embodiments, the central model 416 may determine the hash value is authentic upon the calculated hash and the transmitted hash values matching (e.g., as shown in block 414 of FIG. 4). In other embodiments, the central model 416 may determine the request is invalid and should be rejected if the hash values do not match. In this way, the central model 416 may reject the request, as shown in block 436. In some embodiments, the request rejection may include generating a notification 438, which may include information about the request, the metadata, the reason for rejection, and the like.

As shown in block 312, the process flow 300 of this embodiment includes generating a result via processing the request.

In some embodiments, the central model 416 may process the request 418 to generate a result 420 associated with the request. In some embodiments, the central model 416 may use one or more hyper parameters 434 to process the request. Further, in some embodiments, those hyperparameters may be configured (e.g., as shown in block 432). For example, during training of the central model 416, the training may include configuring or reconfiguring the hyper parameters of the ML model. Further, in some embodiments, the central model 416 may continuously reconfigure the hyper parameters during operation (e.g., during processing of requests).

Further, in some embodiments, the central model 416 may use the processing techniques as described with respect to FIG. 2. Further, in some embodiments, the central model 416 may use sophisticated computing techniques to process the request. In this way, the computational processing power of the central model 416 may be large enough to handle complex computations, which may lead to accurate request results and decisions. For example, the central model 416 may use deep feature extraction techniques, or further transform the data and metadata associated with the request in order to process the request. In other embodiments, the central model 416 may cross-reference external or historical databases, which may or may not relate to the user.

Additionally, or alternatively, the central model 416 may evaluate non-linear relationships between data associated with the request and/or metadata, which may include incorporating higher-dimensional feature spaces and/or performing multi-step computations. In specific embodiments, the central model's 416 processing capabilities may include thorough analysis of the user's request and determining how to best process the request and associated data to reach a particular result.

As shown in block 314, the process flow 300 of this embodiment includes transferring the result to the end-point device. In some embodiments, transferring the result to the end-point device may include generating a hash value, wherein the hash value may include the request and the metadata associated with the request. In some embodiments, transferring the result to the end-point device may include encrypting the result using the hash value. In some embodiments, transferring the result to the end-point device may include decrypting, via the end-point device, the result.

In some embodiments, a public key 424 may be used by the server 130 and/or the central model 416 to encrypt 422 the generated result 420. In this way, the public key 424 may be used to encrypt the metadata associated with the generated result, as well. Further, the encrypted result may be transmitted over the network 110 to the end-point device 140. Further, in some embodiments, the private key 428 may be used to decrypt 426 the result at the end-point device 140. Further, in some embodiments, the end-point device 140 may verify the integrity of the result by computing a hash value from the decrypted decision and comparing the computed hash with the transmitted hash.

In some embodiments, the end-point device 140 may process the decision (as shown in block 430 of FIG. 4). In this way, the end-point device 140 may configure a display (e.g., a user interface as described herein) associated with the end-point device 140 to display the generated result 420. Further, in some embodiments, processing the decision on the end-point device 140 may include the shallow model 402 further processing the decision and/or generated result.

As shown in block 316, the process flow 300 of this embodiment includes rejecting, upon determining the request should not proceed to the central model, the request using the shallow model. In some embodiments, the shallow model, upon the shallow model determining the request should not proceed to the central model, is configured to reject the request.

In some embodiments, the shallow model 402 may determine the request should not proceed to the central model 416 due to the fundamental queries and/or preliminary decisions provided by the user of the end-point device 140. For example, the information associated with the preliminary decisions and/or fundamental queries provided by the user, via the end-point device 140, may result in the shallow model 402 rejecting the request before the request is transmitted to the server 130 and/or the central model 416. In this way, the user's basic information may not meet the requirements for the request to proceed to the central model 416. In a specific example, the user may provide basic information for a request associated with a financial product (e.g., a loan). In this example, if the user does not meet basic criteria for the loan (e.g., credit history), as provided by the user in response to the fundamental queries, the shallow model 402 may reject the request, as shown in block 436.

Additionally, or alternatively, in some embodiments, the shallow model 402 may determine the user's login attempt should be rejected, and the shallow model 402 may generate a rejection (e.g., by rejecting the request as shown in block 436). In this way, the shallow model 402 may determine that the user's attempt to login does not meet the requirements for logging into an account.

In some embodiments, the shallow model 402 may reduce the network traffic when requests are received. For example, the shallow model 402 handling the fundamental decisioning may allow for initial rejections of certain requests that would otherwise have to be decided at the central model 416 or server-side application. In this way, the shallow model 402 may reduce network loads because of the initial decisioning procedures on the user device. Further, in some embodiments, the shallow model 402 may more efficiently direct the user's request after the shallow model 402 has analyzed the request and made the decision to allow the request to proceed. In this way, rather than having the central model 416 decide on how to route the user's request, the shallow model 402 may be able to handle the routing of the request prior to the request being transmitted over the network 110.

As shown in block 318, the process flow 300 of this embodiment may include generating a notification. In some embodiments, the shallow model may be configured to generate a notification associated with the rejection of the request. In some embodiments, the notification may include information including reasons for rejecting the request. In some embodiments, the notification may be generated because of the rejection of the shallow model 402 or the central model 416.

As shown in block 320, the process flow 300 of this embodiment may include configuring a display associated with the end-point device to display the notification. In some embodiments, the shallow model may be configured to configure a display associated with the end-point device to display the notification. In this way, the notification may be displayed on the end-point device 140 for the user to see and understand the decision and/or result generated by the central model 416.

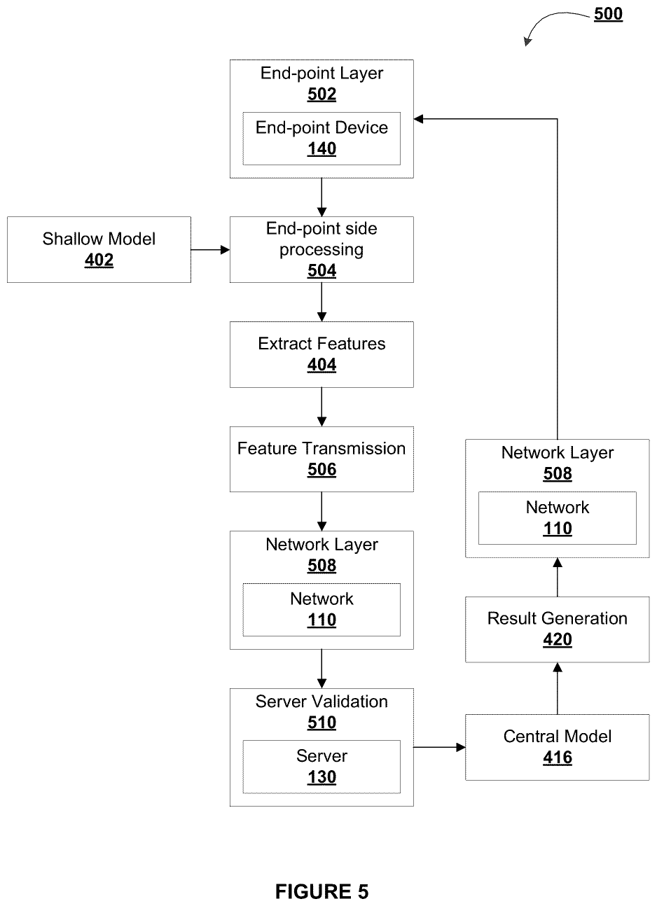

Further, as shown in FIG. 5, the architecture of the solutions as described herein will be discussed. In some embodiments, the end-point layer 502 may include the end-point device 140. The end-point device 140 may perform the end-point side process 504, which may include processing associated with the shallow model 402. Further, the features extracted (e.g., block 404) may be transmitted (e.g., block 506) to the network layer 508. The network layer 508 may include the network 110. Further, the server validation 510 may include the server 130 on which the central model 416 resides. Additionally, the result from the result generation 420 step may be transmitted to the network 110 within the network layer 508. Further, the network 110 may transmit the result to the end-point layer 502 and the end-point device 140.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for decisioning using distributed advanced computational models for data analysis and automated processing, the system comprising:
a processing device;
a non-transitory storage device containing instructions when executed by the processing device, causes the processing device to perform the steps of:
receive a request from an end-point device;
determine, via a shallow model, whether the request should proceed to a central model by determining a preliminary decision associated with the request;
transfer, upon the shallow model determining the request should proceed to the central model, the request and metadata associated with the request to the central model;
generate a result via processing the request using the central model; and
transfer the result to the end-point device.

2. The system of claim 1, wherein the shallow model is associated with the end-point device, and wherein the central model is associated with a server.

3. The system of claim 1, wherein the shallow model is associated with an intermediary server, and wherein the central model is associated with a server.

4. The system of claim 1, wherein the shallow model and the central model include a machine learning (ML) model.

5. The system of claim 4, wherein the ML model associated with the central model comprises at least as many parameters as the ML model associated with the shallow model.

6. The system of claim 1, wherein the shallow model determining the preliminary decision associated with the request comprises resolving one or more fundamental queries associated with the request.

7. The system of claim 1, wherein the shallow model, upon the shallow model determining the request should not proceed to the central model, is configured to reject the request.

8. The system of claim 7, wherein the shallow model is configured to:
generate a notification associated with the rejection of the request; and
configure a display associated with the end-point device to display the notification.

9. The system of claim 1, wherein, upon the shallow model determining the request should proceed to the central model, executing the instructions further causes the processing device to:
generate a hash value, wherein the hash value comprises the request and the metadata associated with the request; and
validate, via the central model, the hash value.

10. The system of claim 1, wherein transferring the result to the end-point device comprises:
generating a hash value, wherein the hash value comprises the request and the metadata associated with the request;
encrypting the result using the hash value; and
decrypting, via the end-point device, the result.

11. A computer program product for decisioning using distributed advanced computational models for data analysis and automated processing, the computer program product comprising a non-transitory computer-readable medium comprising code causing an apparatus to:
receive a request from an end-point device;
determine, via a shallow model, whether the request should proceed to a central model by determining a preliminary decision associated with the request;
transfer, upon the shallow model determining the request should proceed to the central model, the request and metadata associated with the request to the central model;
generate a result via processing the request using the central model; and
transfer the result to the end-point device.

12. The computer program product of claim 11, wherein the shallow model is associated with the end-point device, and wherein the central model is associated with a server.

13. The computer program product of claim 11, wherein the shallow model is associated with an intermediary server, and wherein the central model is associated with a server.

14. The computer program product of claim 11, wherein the shallow model and the central model include a machine learning (ML) model.

15. The computer program product of claim 14, wherein the ML model associated with the central model comprises at least as many parameters as the ML model associated with the shallow model.

16. The computer program product of claim 11, wherein the shallow model determining the preliminary decision associated with the request comprises resolving one or more fundamental queries associated with the request.

17. The computer program product of claim 11, wherein the shallow model, upon the shallow model determining the request should not proceed to the central model, is configured to reject the request.

18. The computer program product of claim 17, wherein the shallow model is configured to:
generate a notification associated with the rejection of the request; and
configure a display associated with the end-point device to display the notification.

19. The computer program product of claim 11, wherein, upon the shallow model determining the request should proceed to the central model, the code further causes the apparatus to:
generate a hash value, wherein the hash value comprises the request and the metadata associated with the request; and
validate, via the central model, the hash value.

20. A method for decisioning using distributed advanced computational models for data analysis and automated processing, the method comprising:
receiving a request from an end-point device;
determining, via a shallow model, whether the request should proceed to a central model by determining a preliminary decision associated with the request;
transferring, upon the shallow model determining the request should proceed to the central model, the request and metadata associated with the request to the central model;
generating a result via processing the request using the central model; and
transferring the result to the end-point device.
